(19) United States
(12) Patent Application Publication
(10) Pub. No.: US 2003/0093420 A1
(43) Pub. Date: May 15, 2003

(54) Method and system for retrieving sharable information using a hierarchically dependent directory structure

(76) Inventor: Kay P. Ramme, Rosengarten (DE)

Correspondence Address: SONNENSCHEIN NATH & ROSENTHAL, East Tower, Suite 600, 1301 K Street N. W., Washington, DC, 20005, US

(21) Appl. No.: 10/260,574

(22) Filed: Oct. 1, 2002

(30) Foreign Application Priority Data
Oct. 2, 2001 (EP) 01 123 243.6

(51) Int. Cl. G06F 7/00

(52) U.S. Cl. 707/3; 707/10; 709/217

(57) ABSTRACT

A method and system for storing and retrieving files is provided, wherein a plurality of directory storage areas are arranged hierarchically in the form of a directed acyclic graph in secondary storage to store files of modules or software components of application programs or operating systems. Shared use of modules or software components is enabled through the use of directory links, enabling access from a module or software component at a first directory storage area to a software component at a second directory storage area. The directory links may be stored in association with the directory storage areas, and may include information of a dependent directory storage area, such as an address or path in a directory tree.

### CROSS REFERENCE TO RELATED APPLICATION

This application is related to, and claims priority to, European Patent Application No. 01 123 243.6, filed on Oct. 2, 2001, commonly owned, and entitled “Shareable Installation Hierarchies,” and which is hereby incorporated by reference herein in its entirety.

1. Field of the Invention

The present invention relates to storage and retrieval of sharable information using a hierarchically dependent directory structure. In particular, this invention relates to a method and system for storing and retrieving sharable information which is stored and retrieved using a hierarchically dependent directory structure.

2. Background Information

Data processing devices are employed in a growing number of fields. In virtually any area of personal and office environments, computerized applications take over tasks and provide services to a user. For example, computerized applications include text processing applications, graphics applications, and other office applications. Further, applications are available for performing banking transactions, retrieving and presenting information, providing communications between users, entertaining users, and controlling computer systems.

Such applications become more and more sophisticated in presentation of information, provision of services and interaction. Various computerized applications may also interact with one another so that very large software systems may be created. The above applications may be executed either on a single data processing device or involve multiple data processing devices, which may be interconnected by direct lines or which may communicate via networks, such as packet switched communication networks.

Instead of a single code module, the above applications typically include a plurality of modules or components, which interact to provide a given functionality. For example, software code of an operating system of a data processing device or system may include a very large number of components in order to facilitate maintenance and updating operations of individual components.

An application or component of an application, after being encoded by a programmer, may be implemented on a data processing device by compiling the respective software code and storing the resulting executable code in a directory in a data storage unit of the data processing device or system. If a large number of components is present, a large number of directories containing executable code may be generated and stored.

In general, software components of an application or group of applications, for example, of an operating system of a data processing device, are installed in such a way that they can refer to one another. Thus, individual components are enabled to make a call to another software component during the execution of an application program or to transfer data or process data. To facilitate such mutual accesses between software components, the components are generally stored in the same space. For example, a first application with all of its associated software components may be stored in a first region of a data storage unit, whereas a second application with all of its associated software components will be stored in a second region of the data storage unit.

However, for this example, since different applications or modules of an application or operating system may use some identical software components (e.g., for input/output operations and display operations), the identical software components may be replicated in different regions of the data storage unit as a copy of the software components for each application that needs them. As a result, redundancy of the installed software is increased and available memory space is consumed.

Further, if these identical software components, installed multiple times for multiple application programs, need to be updated (e.g., an input/output procedure is modified or display characteristics are changed), the corresponding software components must be modified in association with each application program. This increases the complexity of an update operation and thus increases costs.

Therefore, a need has long existed for a method and system that overcomes the problems noted above and others previously experienced.

### SUMMARY OF THE INVENTION

Methods and systems consistent with the present invention provide a method and system for reducing or eliminating redundant storage of files by storing a link, to another directory where a copy of the file is stored, in a directory which needs a copy of the file. This technique may also enable easy movement of files. For information which is sharable among two or more entities such as applications which have module files stored in module directories, the sharable information is stored in one of the directories, and a link to that directory is stored in each of the directories of the modules that share the information. The linking is established hierarchically, in the form of a directed acyclic graph, so that when a file is required for a particular module, a search may be performed by first searching the directory of the module. If the file is not found, then the link is used to access the directory upon which the module's directory depends, so that it may be searched in a similar manner. The search may continue iteratively from one directory to another, until the file is located. Thus, redundant storage of sharable files or software components may be reduced or eliminated, and the files may be conveniently shared by different applications. Further, if the file needs to be modified, an administrator needs only to access and modify one copy of the file, instead of locating and modifying a copy of the file for every module requiring the file.

According to an example, a method in a data processing system having a program and a plurality of directories, a first one of the directories having a link to a second one of the directories, the method comprising the steps of initiating execution of the program; and during execution of the program, accessing the first directory to determine whether a needed file is located in the first directory; and when it is determined that the needed file is not located in the first directory, accessing the link to determine the second directory as an alternative location for the needed file; and accessing the second directory to determine if the needed file is contained therein. The program may be implemented as a script. A file which is sharable among several modules may be stored in a directory associated with one of the modules requiring the file, link information to the directory may be stored in the directories of the other modules requiring the file, and a recursive or iterative search may then be performed on the directories, using the link information, to find the file when it is-needed. The directory storing the file preferably is a directory at the highest level (alternatively, at the lowest level) in the hierarchy of directories among the directories associated with the modules requiring the file. Thus, redundancy of storage of the sharable files is reduced or eliminated and cyclical searching among the directories is avoided.

The first directory link may be stored within the first directory storage area, referring to the second directory storage area as a dependent directory. Thus, for example, if a software component cannot be identified in a directory, the directory link may be identified and the linked directory storage area can be used for obtaining access to the required software component. By storing the directory link within the first directory storage area, access to the link may be achieved directly and without search or lookup operations regarding the directory link, avoiding an increase in system load.

The first directory link may include address information of the second directory storage area, and identifying information with regard to the software components accessible through the directory link, for facilitating access to the second directory storage area using the directory link. If information regarding the software components present at the linked directory storage area is available, a software component may be located beforehand, without actually performing an access operation.

The first directory link may include a path in a directory tree to further facilitate access to the second directory link. Further, the first directory link may include a link file stored in association with the first directory storage area. Thus, the directory link may be easily accessed and modified, for example, if a software component is relocated and associated directory links need to be changed.

A second directory link to a third directory storage area may be stored in association with the second directory storage area and the data related to installed software components may be accessed through the second directory link. Accordingly, access to a software component may be enabled through a concatenation of accesses to directory storage areas through directory links. Further, for example, if a software component is relocated to another directory storage area, instead of modifying all directory links pointing to the software component, a further directory link may be introduced, leading to the new location of the software component from the previous directory storage area.

A directory storage area may include a user directory storage area for storing user software components, wherein the user directory storage area may have stored in association therewith a directory link enabling access to another directory storage area, and including a unit for inhibiting access to the user directory storage area through a directory link. Accordingly, privacy of user directory storage areas may be enhanced by allowing access from a user directory storage area to other directory storage areas using directory links while inhibiting access from a directory storage area to a user directory storage area.

The data storage unit may include a plurality of remote storage devices cooperating via communication links, each storage device including at least one directory storage area. Accordingly, the data storage unit can be arranged in a distributed fashion, with storage devices communicating over communication links such as dedicated communication links or networks.

The data storage unit may form part of a client unit arranged for accessing directory storage areas at a server unit over a network using a directory link. Thus, directory storage areas may be accessed in a client and server system over a communication network such as the Internet. Likewise, the data storage unit may form part of a server unit arranged for allowing access from a client unit to directory storage areas at the server unit over a network using a directory link.

According to another example, a method for accessing software components in a data storage unit including a plurality of directory storage areas, each of the directory storage areas storing data related to installation of software components, includes receiving a call for a software component at a first directory storage area; reading a first directory link to a second directory storage area, the first directory link being stored in association with the first directory storage area; and accessing data related to installation of software components using the first directory link.

Other apparatus, methods, features and advantages consistent with the present invention will be, or will become, apparent to one with skill in the art upon examination of the following figures and detailed description. It is intended that all such additional systems, methods, features and advantages be included within this description, be within the scope of the present invention, and be protected by the accompanying claims.

### BRIEF DESCRIPTION OF THE DRAWINGS

FIG. 1 depicts a block diagram of an exemplary data processing system suitable for practicing methods and implementing systems consistent with the present invention.

FIGS. 2a-2b depict a flowchart of a method for accessing files associated with modules according to an exemplary embodiment consistent with the present invention.

FIG. 3 depicts a data storage unit with sharable installation hierarchies according to an exemplary embodiment consistent with the present invention

FIG. 4 depicts a data storage unit according to another exemplary embodiment consistent with the present invention particularly showing elements of a directory storage area.

FIG. 5 depicts a data storage unit according to another exemplary embodiment consistent with the present invention particularly showing an example of possible dependencies through directory links among a plurality of directory storage areas.

FIG. 6 depicts operations of a method for accessing software components in a storage unit according to another exemplary embodiment consistent with the present invention

FIG. 7 depicts a data storage unit according to another exemplary embodiment consistent with the present invention particularly showing a server and client example.

### DETAILED DESCRIPTION

Methods and systems consistent with the present invention provide a method and system for reducing or eliminating redundant storage of files by storing a link, to another directory where a copy of the file is stored, in a directory which needs a copy of the file. This technique may also enable easy movement of files. For information which is sharable among two or more entities such as applications which have module files stored in module directories, the sharable information is stored in one of the directories, and a link to that directory is stored in each of the directories of the modules that share the information. The linking is established hierarchically, in the form of a directed acyclic graph, so that when a file is required for a particular module, a search may be performed by first searching the directory of the module. If the file is not found, then the link is used to access the directory upon which the module's directory depends, so that it may be searched in a similar manner. The search may continue iteratively from one directory to another, until the file is located. Thus, redundant storage of sharable files or software comporents may be reduced or eliminated, and the files may be conveniently shared by different applications. Further, if the file needs to be modified, an administrator needs only to access and modify one copy of the file, instead of locating and modifying a copy of the file for every module requiring the file.

Reference will now be made in detail to an implementation in accordance with methods, systems and apparatus consistent with the present invention as illustrated in the accompanying drawings. The same reference numerals may be used throughout the drawings and the following description to refer to the same or like parts.

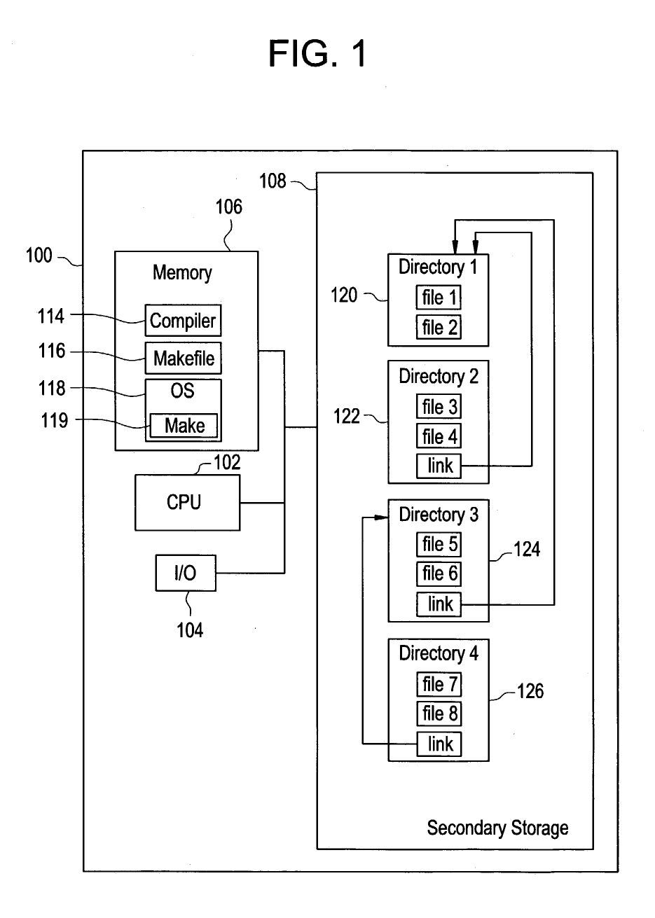

FIG. 1 depicts a block diagram of an exemplary data processing system 100 suitable for practicing methods and implementing systems consistent with the present invention. The data processing system 100 includes a central processing unit (CPU) 102, an input-output (I/O) device 104, a memory 106, and a secondary storage device 108. The data processing system 100 may further include input devices such as a keyboard, a mouse or a speech processor (not shown).

The memory 106 embodies a compiler program 114 that may communicate, e.g., via message passing or function calls with an operating system program 118, a make program 119, and a makefile 116, also stored in the memory 106. The compiler 114 represents a program running on the data processing system 100 that processes input source code to generate executable code. The makefile 116 represents a program that searches for files required by the compiler 114. The make program 119, which, for example, may be a utility of UNIX, interprets the makefile 116. The makefile 116 may include a script, which may be a program. The compiler 114 may compile code to generate executable code for an application such as a word processor, a low level operating system program, an entertainment application, or a spreadsheet application.

The secondary storage device 108 includes directories 120, 122, 124 and 126 which contain files which are required for execution of predetermined applications. A particular application is associated with a predetermined directory 120, 122, 124, or 126. For this example, the directory 120 stores files that are needed by the application associated with the directory 122. A link including location information about the directory 120 is thus stored in the directory 122. The directory 124 includes a link which has location information about the directory 120. Thus, if a search is performed on the directory 124 for a particular file which is not stored in the directory 124, the link may be used to access and search the directory 120 for the file. As shown, the directory 126 includes one link having location information about the directory 124. Thus, if a predetermined file is not stored in the directory, a search may use the link to access the directory 124 to iteratively search until the file is found. For example, if a file needed by the application associated with directory 126 needs the file designated as “file1” in FIG. 1, the search may begin by searching the directory 126, then follow the link to directory 124 to iteratively search the directory 124, and follow the link stored in the directory 124 to iteratively search the directory 120, where the file is located. For this example, this particular arrangement of the files and links imposes a hierarchical structure on the directory storage, in the form of a directed acyclic graph

Exemplary systems suitable for practicing methods and implementing systems consistent with the present invention may include networked, or otherwise interconnected systems, each having a structure similar to that shown in FIG. 1.

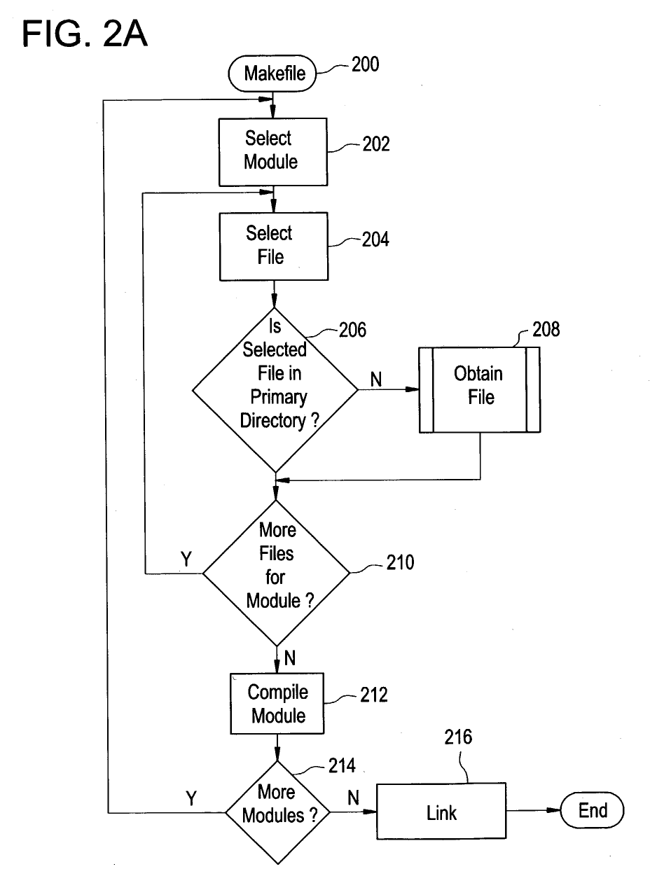

FIGS. 2a-2b depict a flowchart of a makefile 200 for accessing files associated with modules according to an exemplary embodiment consistent with the present invention. This method may be performed by the makefile 116 shown in FIG. 1 for searching the directories 120, 122, 124 and 126 in secondary storage 108 of FIG. 1 for a predetermined file associated with a predetermined application or module.

The makefile 200, in step 202 of FIG. 2a, selects a module. This may be a module needed by a compiler such as the compiler 114 shown in FIG. 1. In step 204, the makefile 200 selects a file needed for the module. In step 206, the makefile determines whether the selected file is in a primary directory of the module. The primary directory may be the directory 120, 122, 124 or 126 associated with the module. If the selected file is not in the primary directory, the makefile 200 obtains the file 208 which is described in greater detail below.

If the selected file is in the primary directory, in step 212, the module is compiled. In step 214, it is determined whether there are more modules to compile. If there are no more modules to compile, the modules are linked in step 216. If there are more modules to compile, then control passes to step 202 to iteratively find all the files for all modules that need to be compiled.

FIG. 2b further describes the steps performed by the makefile 200 at the obtain file step 208 of FIG. 2a. In step 250, the makefile 200 accesses a link to determine an address of a next directory to search for the file. In step 252, the makefile 200 searches the directory accessed by using the link to determine whether the file is located in the directory. If the file is not in the directory, control passes to step 250 to obtain a link for the directory and to continue iterative searching. If the file is determined to be in the directory at step 252, then control is returned to step 210 of the makefile 200. The steps performed by the makefile 200 are similar to steps of an exemplary makefile which is listed and described below. It is noted that a script is an example of a program.

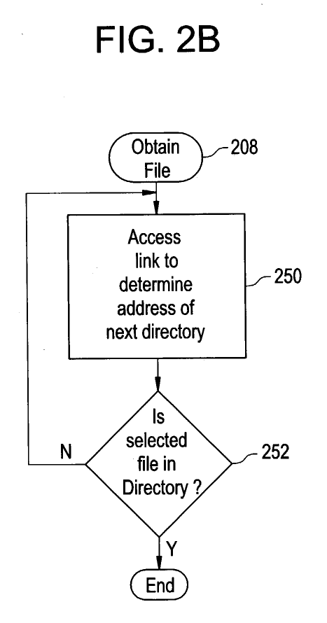

FIG. 3 depicts a data storage unit with sharable installation hierarchies according to an exemplary embodiment consistent with the present invention A data storage unit 300 includes sharable installation hierarchies including a first directory storage area 310 and a second directory storage area 320, each of the directory storage areas for storing data related to installed software components or modules. A first directory link 311 to the second directory storage area 320 is stored in association with the first directory storage area 310, for enabling access to data related to installed software components using the first directory link.

In the exemplary embodiment of FIG. 3, the second directory storage area 320 is accessible from the first directory storage area through the directory link 311, as illustrated by the arrow 312. Thus, for example, if a software component installed at the first directory storage area requires a software component which is available at the second directory storage area 320, this software component can be accessed through the directory link 311, including retrieving the software component, transferring data, and processing operations. Accordingly, it is not necessary to replicate all software components in all directory storage areas of the data storage unit, as software components may be provided only once in a specific directory storage area and all other directory storage areas possibly requiring such software components may be linked to the specific directory storage area.

The first directory link may be stored within the first directory storage area, in order to avoid computationally intensive lookup operations in order to identify the directory link at another location. If, for example, a software component cannot be located within a particular directory storage area, an application program could effect detection of all directory links stored within the directory storage area and proceed to locate the desired software component through the directory links.

However, it is also possible that the directory links are stored remote from the corresponding directory storage areas, for example, in a data base of directory links, where they can be accessed from the directory link searching for a particular software component not located at that directory storage area.

Further, the first directory link may include address information of the second directory storage area and identifying information of the directory components accessible through the directory link. For example, information could be maintained in association with the directory link, such as which software components or types of data are accessible through the directory link, or which functionality can be invoked using the directory link. This information may be stored in a list of software components or available functions installed at the second directory storage area and/or further information regarding directory links available at the second directory storage area. Alternatively, it is also possible that the identifying information regarding the software components accessible through the directory link is maintained at a central location, to be obtained in a lookup operation. By providing address information of the second directory storage area in association with the directory link, direct access to the second directory storage area is enabled.

Further, the first directory link may include a path in a directory tree, for example, a directory tree of a file system storing a large number of installed software components and possibly further information relating to an operating system. However, it is also possible that the first directory link includes a link file stored in association with the first directory storage area. This link file may conveniently be maintained at the directory storage area, can be reviewed by a user or system administrator and may store all necessary link information such as address information of the second directory storage area and any information, if provided, of the software components available at the second directory storage area and/or further directory links to further directory storage areas, including software components located at such further dependent directory storage areas. The link file may be conveniently edited by the user or system administrator and modified, if installed software components are relocated within the data storage unit.

The second directory storage area 320 may include a second directory link (not shown in FIG. 3) pointing to a third directory storage area, and data related to required installed software components may be provided at the third directory storage area, to be accessed through the second directory link. Further stages of linked directory storage areas are possible, such that access to an installed software component may be obtained through a plurality of directory links.

Allowing access to a required installed software component through multiple directory links provides a high degree of flexibility. For example, if software components are relocated from one directory storage area to another directory storage area, or when removing a directory storage area, e.g., when updating or modifying an operating system, updating all directory links to a specific directory storage area can be a time consuming process. Further, depending-on availability of information on directory links listing a particular modified or deleted directory storage area as a dependent directory storage area, it may be difficult to update all directory links. This may lead to problems during operation, as it may become impossible to locate software components which have been moved from other directory storage areas.

To avoid these problems, according to the present embodiment, if software components are relocated from a first directory storage area to a second directory storage area, there may be included an additional directory link into the first directory storage area to the second directory storage area. Thus, any application program accessing the first directory storage area regarding software components originally stored at this directory storage area will be redirected through the directory link to the second directory storage area now storing the software component. Thus, complicated updating operations of a potentially large number of directory links can be minimized or avoided.

In the following discussion, further examples of the elements of the data storage unit illustrated in FIG. 3 is described in further detail. It is noted that the following description provides examples only and should not be understood as limiting.

In FIG. 3, the first and second directory storage areas 310 and 320 may include any type of computer memory or data storage devices such as a RAM, magnetic or optical storage. For example, the first and second directory storage areas may include storage areas of a memory subdivided into a number of directory storage areas or may include separate memory units connected to one another to exchange data. A directory storage area may also be a simulated file folder on a-memory unit, including indexes to files, such as installed software components, which are stored in the file folders which, however, may physically be scattered on the memory unit. Thus, a directory storage area may be a physically separate unit or may be a virtual concatenation of tracks or other units in a memory.

The data storage unit 300 illustrated in FIG. 3 may itself be a single device, such as a single optical, magnetic or other data storage unit, or may include a collection of such devices. Further, the data storage unit may be included into a single data processing device, such as a general purpose data processing device, a mobile computing device, such as a mobile data organizer or mobile communication unit, including a mobile telephone. Further, the data storage unit if formed by a plurality of single units, may be distributed onto a plurality of data processing devices. The individual data processing devices may be arranged in a network, such as a packet switched network, including a local area network or the Internet, or may be connected by dedicated communication links.

Each directory storage area may be arranged to store data related to installed software components of any type of application, including operation systems, user applications such as text processing applications, spread sheet applications, and communication applications. It is also possible that the data storage unit forms part of a server and client system, wherein the data storage unit is arranged at the server unit and can be accessed through a plurality of client units, which may access the server unit from remote locations. The client units could be enabled to use resources of the server unit, e.g., of application programs, the software components of which are stored in the directory storage areas.

A software component may include a collection of instructions to make a data processing device to carry out a particular function and may be present in a form which is directly executable by a data processing device. For example, the data of the installed software components could be produced by a compiler processing source code written by a programmer. Further, a directory storage area could store software components in a form which requires an interpreter for execution.

Current application programs may include a potentially large number of software components, wherein the execution of one software component may require a call to another software component. Thus, software components related to an application are usually stored in a defined area of a data storage device, in order to allow one software component to make a call or access another software component. Further, in current computer systems it is also possible that different applications partially rely on the same software components, for example, for input or output operations, display operations on a monitor.

Accordingly, a first application program may store software components related to the first application program in a first directory storage area, while a second directory storage area stores software components related to a second application program. Commonly used software components could be stored in one of the first and second directory storage areas, or alternatively in a third directory storage area. In order to avoid redundant storage of software components utilized by both the first application program and the second application program in the first and second directory storage area, a directory link between the directory storage areas is provided. For example, commonly used software components such as for input/output or certain mathematical operations, may be stored in one of the first and second directory storage areas or may be stored in yet another directory storage area, while the first and/or second directory storage area stores a directory link pointing to the directory storage area actually storing the commonly used software components. If the commonly used software components are stored in the second directory storage area, the first directory storage area will store a directory link to the second directory storage area, or likewise, if the commonly used software components are stored in a third directory storage area, both the first and second directory storage area will store a directory link to the third directory storage area.

The directory link may in general be implemented as any kind of link information allowing access from one directory storage area to another directory storage area. For example, the directory link may include address information of the directory storage area actually storing a desired software component, enabling a data processing unit to follow the link for making a call from one software component stored in one directory storage area to another software component stored at another directory storage area. This link information may also include a path in a directory tree. The link may be a real link, such as a Unix link, or it may be implemented as a file with a directory specification stored in association with the directory storage area.

The link file may include all necessary information for accessing another software component, i.e., may include information on a dependent directory storage area and optionally, may include information on software components available at the dependent directory storage area. A user or system administrator may conveniently edit and update or modify the link file, if required. For example, the link information may thus be stored as ASCII information which can be edited using a standard text processing application. However, it is also possible that the link information of the link file is stored in a machine executable format, and that changes to the link file are effected with a specific application program, enabling a user to modify or update the link information.

While the directory link file or the directory link in any format may be stored directly at the directory storage area, it is also possible that the directory link is maintained at another location, such as a link directory. In this case, if a software component needs to make a call to another software component which is not located at the same directory storage area, the link directory could be investigated in order to identify a directory storage area storing the required software component.

Access from one directory storage area to another directory storage area can then be gained through any kind of communication link, including an internal connection of a data processing device, a dedicated communication path, or a network connection. Further, a directory storage area may include a plurality of directory links to dependent directory storage areas.

In the following example, an implementation of an exemplary embodiment in connection with the SUN ONE webtop installation will be outlined. SUN ONE webtop allows users operating client devices to access resources at a server unit through communication networks or communication links. For example, a user may access a text processing application at a server unit through a client computer remotely logged in to the server unit. The client unit may then be used to control an editing application, editing a document, which may, for example, be located at the server unit. Screen contents for controlling the application may be provided to the client unit for local display.

A data storage unit of the SUN ONE webtop installation may include a plurality of directory storage areas storing software components of the various modules of the installation.

A SUN ONE webtop installation using the link concept of the present example may appear as depicted in the encoding examples shown below.

For the purposes of these examples, ->corresponds to a directory link to another directory storage area.

Directory Storage Area: UDK (UNO Development Kit):

configuration/*.rdb //this is the basic configuration, e.g., which components are installed and which types exist

includes/*.hxx //these are includes which only depend on system headers

makefiles/*.mk //these are the basic makefiles, with standard defines

libraries/lib*.so //these are basic libraries

applications/*.bin //these are the basic UNO applications (regview, regmerge, . . . )

Directory Storage Area: ODK (Office Development Kit):

->UDK

configuration/*.rdb //describes the office api

libraries/lib*.so //office components

applications/*.bin //soffice.bin—the office application

Directory Storage Area: WDK (Webtop Development Kit):

->ODK

configuration/*.rdb //describes webtop api

includes/*.hxx //additional headerfiles

makefiles/*.mk //additional makefiles, e.g., with new or changed settings

libraries/lib*.so //webtop components and libraries

applications/*.bin //webtop applications (sportald.bin, . . . )

html/*.html //html

Directory Storage Area: Third Party Product:

->ODK

configuration/*.rdb //types defined by third party

includes/*.hxx //additional headers

libraries/lib*.so //additional libraries and components

applications/*.bin //additional applications

Directory Storage Area: office user installation (not sharable):

->ODK

configuration/*.rdb //this users configuration

As can be seen from the above examples, each directory storage area contains a storage area of the software components needed for the SUN ONE webtop installation. In order to avoid replication of components for smooth operation of the system, links to the other components residing on the other directory storage areas are provided. The directory storage areas, if required, i.e., if access to other software components from this directory storage area is required, include respective links to the other directory storage areas. For example, the directory storage area ODK includes a directory link to the directory storage area UDK, and the directory storage area WDK includes a directory link to the directory storage area ODK. In operation, invoking software components at the directory storage area WDK relating to the SUN ONE webtop development kit may require accessing software components describing the office api (application program interface). As these software components are stored at the directory storage area ODK, and since a directory link to the directory storage area ODK is stored at the directory storage area WDK, the software components describing the office application program interface may be accessed, enabling a smooth execution of the software components at the webtop development kit. If the software components describing the office application program interface require software components of the directory storage area UDK, those software components can be accessed through the corresponding link to the directory storage area UDK stored at the directory storage area ODK.

During operation, if a particular software component cannot be identified at a current directory storage area, a controlling data processing unit executing the software components or any other unit may be instructed to search for any directory links stored in, or in association with, the current directory storage area. If directory links are identified, linked directory storage areas may be accessed in order to obtain the required software components. This may be done in a sequential manner, i.e., a first identified directory link may be used to access a dependent directory storage area in searching for a software component, and then further directory links could be considered.

If information on the software components at a linked directory storage area, i.e., a directory storage area through a directory link, is maintained in association with the directory link, the directory link may first be analyzed in order to identify whether the linked directory storage area should actually be accessed or not. Maintaining information on software components available at link directory storage areas avoids a requirement of performing actual access operations.

It is noted that the above described operations for controlling the data storage unit may at least partially be realized as software or hardware. The control may be carried out using dedicated hardware or a correspondingly programmed data processing device.

Two sample makefiles, for further describing an exemplary implementation of a search for a file using the makefiles for a similar structure to the structure of the above example, are shown below. It is noted that a “#” in the left margin denotes a comment used to explain the code to human readers. An exemplary directory structure which may be used by the makefile is depicted by:

udk/binaries

udk/makefiles/defines.mk

udk/includes

udk/libraries

odk/master ->udk # a symbolic link pointing to the udk

odk/makefiles

odk/binaries

odk/includes

odk/libraries

wdk/master ->odk # a symbolic link pointing to the odk

wdk/makefiles

wdk/binaries

wdk/includes

wdk/libraries

wdk/source/Makefile

# Below is an exemplary “defines.mk” file, which may be located in the “makefiles” # directory of the “udk” directory, as shown above.

CFLAGS+=-g

# In this defines.mk

# a typically predefined “CFLAGS”

# variable is extended with the “-g” option. The “-g”

# option lets e.g. the GNU

# c-compiler emit debugging information.

# it is possible to add other switches, e.g.

# to optimize code or to use a specific

# calling convention.

# Below is a sample makefile which uses

# separate directory storage areas of

# software modules which may have dependencies to other software modules.

# It is assumed that every directory

# storage area has defined the following

# directories (this is the “STRUCTURE”

# of the directory storage areas):

# binaries—for executables

# libraries—for shared libraries

# includes—for include files

# makefiles—for additional makefiles (e.g. with defines)

# master—this is optional, if it is present it should point

# to the master directory storage area of this directory

# partition

# For this example, we use the term “directory storage area” for every

# instance of the above described directory structure. So, in general,

# a directory storage area includes a set of directories in the file

# system, which follow a separately defined structure.

# In this exemplary makefile

# two types of string values are used:

# separated lists of paths to directories, which are further

# on called space-path-lists

# specific lists of paths to directories (either colon separated

# or -I separated, where the -I separated paths are passed

# to e.g. a c-compiler as command line arguments), which

# are further on called specific-path-lists

# some help variables

empty:=

space:=$(empty) $(empty)

colon:=:

# This gives a space-path-list, for which entries point to

# all master directory storage areas.

MASTERS_SPACE_PATH_LIST=$(shell LIST=;PTH=.;while test -e $$PTH/master;do PTH=$$PTH/master;LIST=$$LIST\$$PTH;done;echo $$LIST)

# The value of MASTERS_SPACE_PATH_LIST, after executing the script, is:

# MASTERS_SPACE_PATH_LIST=./master ../master/master

# space-path-lists are now generated from the MASTERS_SPACE_PATH₁₃ LIST

# which are used to search for specific types of files.

# The space-path-lists become created by extending the

MASTERS_SPACE_PATH_LIST

# entries with the names of the special directories:

BINARIES_SPACE_PATH_LIST:=../binaries $(foreach m, $(MASTERS_SPACE_PATH_LIST), $(m)/binaries)

LIBRARIES_SPACE_PATH_LIST:=../libraries $(foreach m, $(MASTERS_SPACE_PATH_LIST),$(m)/libraries)

INCLUDES_SPACE₁₃ PATH_LIST:=../includes $(foreach m, $(MASTERS_SPACE_PATH_LIST),$(m)/includes)

MAKEFILES_SPACE_PATH_LIST:=../makefiles $(foreach m, $(MASTERS_SPACE_PATH_LIST),$(m)/makefiles)

# The values of the above variables after evaluation are:

# BINARIES_SPACE_PATH_LIST=../binaries ../master/binaries ../master/master/binaries

# LIBRARIES_SPACE_PATH_LIST ../libraries ../master/libraries ../master/master/libraries

# INCLUDES_SPACE_PATH_LIST=../includes../master/includes ../master/master/includes

# MAKEFILES_SPACE_PATH_LIST=../makefiles ../master/makefiles ../master/master/makefiles

# specific-path-lists are now generated from the above # space-path-lists.

# The BINARIES_SPECIFIC_PATH_LIST variable is used

# to extend the systems “PATH” variable. Thus, we

# adopt the systems style of a path list, which is typically

# a colon separated list of paths (Windows/Unix).

# The same holds true for the LIBRARIES_SPECIFIC_PATH_LIST.

# The separator for the INCLUDES_SPECIFIC_PATH_LIST is “-I”,

# so that it may be passed to the compiler while invoking it.

# This is not required with the MAKEFILES_SPACE_PATH_LIST variable,

# as there is no built-in search mechanism for makefiles we might

# utilize. So, if it is desired to include a makefile we

# search for it explicitly.

BINARIES_SPECIFIC_PATH_LIST: =$(subst $(space),$(colon), $(BINARIES_SPACE_PATH_LIST))

LIBRARIES_SPECIFIC_PATH_LIST:=$(subst $(space),$(colon), $(LIBRARIES_SPACE_PATH_LIST))

INCLUDES_SPECIFIC_PATH_LIST:=$(subst $(space),$(space)-I, $(INCLUDES_SPACE_PATH_LIST))

# The values of the above variables after evaluation are:

# BINARIES_SPECIFIC_PATH_LIST=../binaries:../master/binaries: ../master/master/binaries

# LIBRARIES_SPECIFIC_PATH_LIST=../libraries:../master/libraries: ../master/master/libraries

# INCLUDES_SPECIFIC_PATH_LIST=-I../includes -I../master/includes -I../master/master/includes

# Define a find function, which searches a space-path-list

# for a file and returns a valid path to the file itself.

find=$(shell location=;for i in $(1);do if test -e $$i/$(2);then location=$$i/$(2);break; fi done; echo $$location)

# Use OS support for the different system paths.

# Extend the systems “PATH” environment variable, so

# from this point on we can execute any executable

# which be can be found in the hierarchy of directory storage areas

# and which is located somewhere in the “binaries” directories,

# by invoking it.

PATH:=$(PATH): $(BINARIES₁₃ SPECIFIC_PATH_LIST)

# we extend the LD_LIBRARY_PATH environment variable, so

# from this point on we have access to any shared library

# which be can be found in the hierarchy of directory

# storage areas and which is located somewhere in the “libraries”

# directories.

LD_LIBRARY_PATH:=$(LD_LIBRARY_PATH):$(LIBRARIES_SPECIFIC_PATH_L IST)

# This is an example for including a makefile with defines.

# The file itself is called “defines.mk” and, if used, may be located

# somewhere in the hierarchy of directory storage areas in a directory

# called “makefiles”.

include $(call find,$(MAKEFILES),defines.mk)

# If the “defines.mk” file is located in the udk/makefiles

# directory, the call expression shown above results in:

#../master/master/makefiles/defines.mk

# “echotarget” is a dummy target, to print out the

# values of some variables:

echotarget:

@echo MAKEFILES: $(MAKEFILES)

@echo PATH: $(PATH)

@echo INCLUDEPATH: $(INCLUDEPATH)

@echo LD_LIBRARY_PATH: $(LD_LIBRARY_PATH)

@echo CFLAGS: $(CFLAGS) # extend by the above included makefile

# Background regarding the find function:

# Make, at least GNU make in version 3.79, supports using variables as

# functions. Parameters are passed via the $(1), $(2), . . .

# variables. The expression after the include directive just

# calls the find variable as a function. It replaces the above

# mentioned variables $(1) and $(2) with $(MAKEFILES) and defines.mk.

# So, by inlining the function the expression may become:

# include $(shell location=;for i in $(MAKEFILES);do if test -e $$i/define.mk;then

# location=$$i/$(2);break; fi done; echo $$location)

# If we continue evaluating the above expression and expand $(MAKEFILES) variable,

# the expression may be:

# include $(shell location=;for i in ../makefiles ../master/makefiles

#../master/master/makefiles;do if test -e $$i/define.mk;then location=$$i/$(2);break; fi

# done; echo $$location)

# The for loop now iterates over the space-path-list and concatenates defines.mk to the

# different entries. The “test” operation then tests if there is a file called

#./makefiles/defines.mk or ../master/makefiles/defines.mk, . . . for example.

# If the file exists, it terminates and gives the path as a result back.

# So, after calling the find function on a space-path-list and a file's name,

# we have as a result the path to that file. In the example makefile we now

# use the path to the defines.mk file to include it.

Thus, a search for a particular file is initiated at a master directory associated with a particular software component or module needing the file. The master directory may be searched iteratively for the file using the “test” command, which returns a value of “true” if found, and “false” if not found. If the file is not found, the link stored in the directory is used to obtain the location of the next directory in the hierarchical progression, and the strings representing paths being traversed are concatenated to form a path which may be used to iteratively access and search directories through the hierarchy until the file is found. The links stored in the directories' storage areas may be implemented by using a make symbolic link command of UNIX.

It is pointed out that two different makefiles are shown in the preceding section of code and commentary, which are intended as examples only, and are in no way intended to limit the invention to these examples. Thus, one skilled in the art will recognize that there numerous ways of achieving the desired search for the file in the directories using links.

Reference materials which may be helpful for making and using code similar to the preceding examples are readily available commercially, such as Unix: The Complete Reference, by Rosen and Host, published by McGraw-Hill Osborne Media, 1999.

Further, it is noted that a computer-readable medium may be provided having a program embodied thereon, where the program is to make a computer or system of data processing devices execute functions or operations of the features and elements of the above described examples. A computer-readable medium can be a magnetic or optical or other tangible medium on which a program is recorded, but can also be a signal, e.g., analog or digital, electromagnetic or optical, in which the program is embodied for transmission. Further, a computer program product may be provided comprising the computer-readable medium.

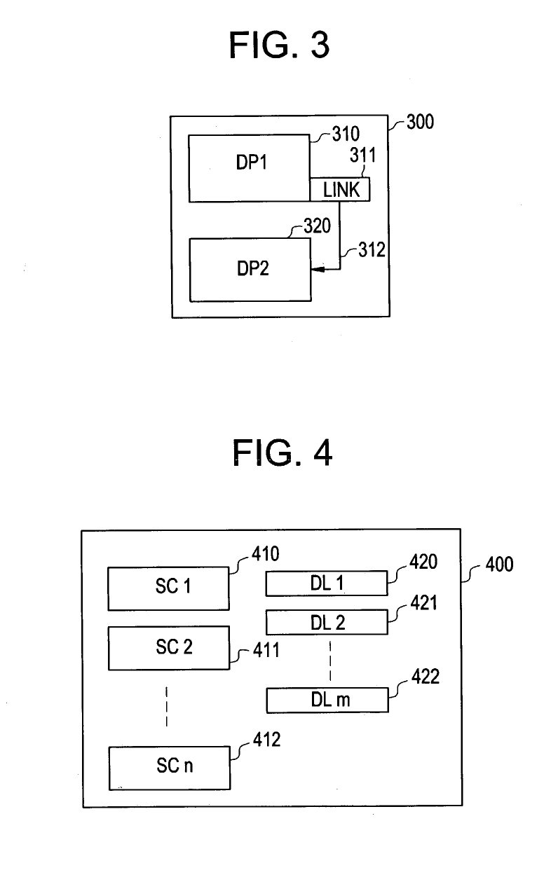

FIG. 4 depicts a data storage unit according to another exemplary embodiment consistent with the present invention particularly showing elements of a directory storage area. A directory storage area 400 includes a plurality of software components 410, 411, and 412. While only three software components are shown, it is understood that an arbitrary number of software components may be provided. Further, the directory storage area 400 shown in FIG. 4 includes a plurality of directory links 420, 421 and 422, although an arbitrary number of directory links could be provided.

As described previously, the directory storage area 400 may include a contiguous physical space on a data storage device, such as a particular defined storage area a recording medium. Further, it is possible that the directory storage area 400 includes a concatenation of disjoint storage areas of a data storage device. Additionally, the directory storage area may include a data storage device, such as a hard-drive, or other recording device, arranged for communicating with other directory storage areas on other data storage devices.

The software components 410, 411 and 412 shown in FIG. 4 may relate to any application program or operation system, as, for example, the operation system of the SUN ONE webtop installation discussed previously. For example, the directory storage area 400 shown in FIG. 4 may store software components related to a particular type or group of functionalities of a larger system.

The directory links 420, 421 and 422 shown in FIG. 4 provide links to further dependent directory storage areas storing further software components which may need to be accessed from the software components of the directory storage area 400. The links 420, 421 and 422 may be stored within the directory storage areas or may be stored at a separate locations, for example, in a directory file storing information in association with some or all of the directory links of the directory storage area 400. Each directory link may include information for accessing a dependent directory storage area, such as address information or a path in a directory tree.

Optionally, the directory links may include information on software components available at the respectively linked directory storage areas. If information on software components is available with the directory links, the directory links may be analyzed in order to identify a directory storage area storing a desired software component. If such a software component cannot be identified in the directory storage area, such as directory storage area 400 or any of the directory links, the respective dependent directory storage areas can then be accessed, in order to identify further directory links at the dependent directory storage areas in order to search for the desired software component using the directory links at the dependent directory storage area. In a further search stage, if a desired software component is not be located, further dependent directory storage areas may be identified and accessed in search of the desired software component.

While it is possible that directory links and software components are handled on a physical level, i.e., in the physical storage space-related to a directory storage area, it is also possible that accesses from one software component through a directory link to software components at another directory storage area are managed on a higher system layer, for example, a system layer maintaining information on directory storage areas (e.g., virtual directory storage areas or physical directory storage areas) and corresponding directory links. Thus, a control layer could maintain information on physical storage spaces defining a directory storage area and information on associated directory links to further directory storage areas in order to be able to handle an access from one directory storage area to another directory storage area through a directory link.

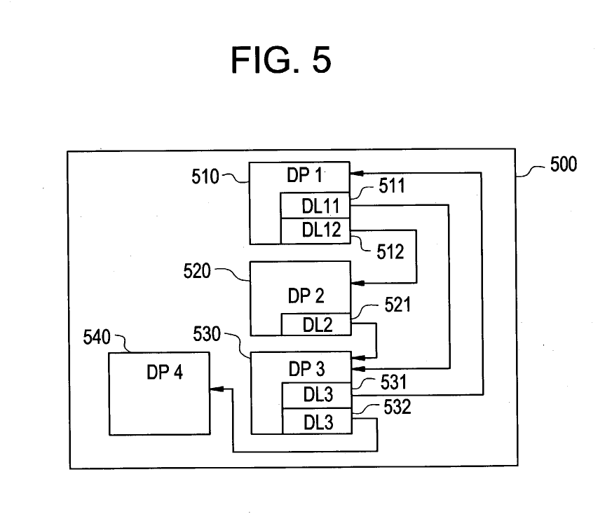

FIG. 5 depicts a data storage unit according to another exemplary embodiment consistent with the present invention particularly showing an example of possible dependencies through directory links among a plurality of directory storage areas.

FIG. 5 shows a directory storage area 500, which may be similar to the directory storage areas outlined with respect to previous embodiments.

The directory storage area 500 includes four directory storage areas 510, 520, 530 and 540, although any number of directory storage areas may be provided. Each of the directory storage areas 510, 520, 530 and 540 is arranged to store installed software components, e.g., compiled source code, code for further processing through an interpreter or linker or of one or a plurality of arbitrary application programs.

Further, it is assumed that directory storage area 510 includes two directory links 511 and 512, pointing to dependent directory storage areas. In the present example, it is assumed that directory link 511 points to the third directory storage area 530 and that the directory link 512 points to the second directory storage area 520. Thus, software components located at the first directory storage area 510 may be enabled to make calls or transfer data or retrieve data from software components located at the second directory storage area 520 and third directory storage area 530.

The directory links enable a linking of the dependent software components or execution of any provided data, which are reachable through the directory link.

Further, in the example of FIG. 5 it is assumed that the second directory storage area 520 includes a directory link 521, linking the third directory storage area 530. Additionally, it is assumed that the third directory storage area 530 includes a directory link 531 linking the first directory storage area 510. Thus, for this example, the directories 510, 520, 530 and 540 include cyclic dependencies. Therefore, a cycle detection scheme may be used to provide a termination of the searching performed in the directories 510, 520, 530 and 540.

Accordingly, it is possible that accesses from software components to other software components on other directory storage areas are carried out through one or more directory links, which may lead to a constellation, as shown in FIG. 5, wherein a software component at the first directory storage area 510 accesses a software component at the second directory storage area 520, which in turn accesses a software component at the third directory storage area 530 through the directory link 521, and that this software component at the directory storage area 530 accesses through link 531 a software component again at the first directory storage area 510.

It is noted that the directory links 511, 512, 521 and 531 may be stored in the directory storage areas or in association with the respective directory storage areas.

In the example of FIG. 5, if the software components of the one or plurality of application programs stored in the directory storage areas shown in FIG. 5 are updated or modified, or if further software components are introduced, it may happen that a software component located at the third directory storage area 530 is relocated to the fourth directory storage area 540 (or any other directory storage area).

In order to enable software components at the first and second directory storage and 510 and 520 to access the relocated software components now at directory storage area 540, the respective links 511 at the first directory storage area 510 and the directory link 521 at the directory storage area 520 may be modified to list the fourth directory storage area 540 as the dependent directory storage area. For this example, two access and update operations are required. If a large number of directory storage areas and links is present, this operation may, however, involve a substantially larger number of access and update operations, resulting in a time consuming process.

Thus, instead of modifying the directory link 511 and 521, a further directory link 532 may be included in the third directory storage area 530. This directory link 532 now lists the fourth directory storage area maintaining the relocated software components as dependent directory storage area. A request to access to a software component originally located at the third directory storage area 530 can now be redirected to the fourth directory storage area 540. Thus, only a single further link needs to be included in order to maintain accessibility of the software components relocated to the fourth directory storage area 540.

In operation, a software component at the directory storage area 510, for example, may still access the third directory storage area 530, in order to determine that the software components can now be accessed through the directory link 532 at the fourth directory storage area 540.

While according to the second option the update operation is fairly straightforward and simple, i.e., by including another directory link, the actual access to a linked software component involves further steps, which may lead to a time lag. Therefore, if software components of a directory storage area are to be relocated, where the directory storage area is only listed in a few directory links as a dependent directory storage area, the respective links may be updated, while if a large number of directory storage areas, or if not all directory storage areas are known which list this directory storage area as a dependent directory storage area, a further link such as link 532 may be introduced.

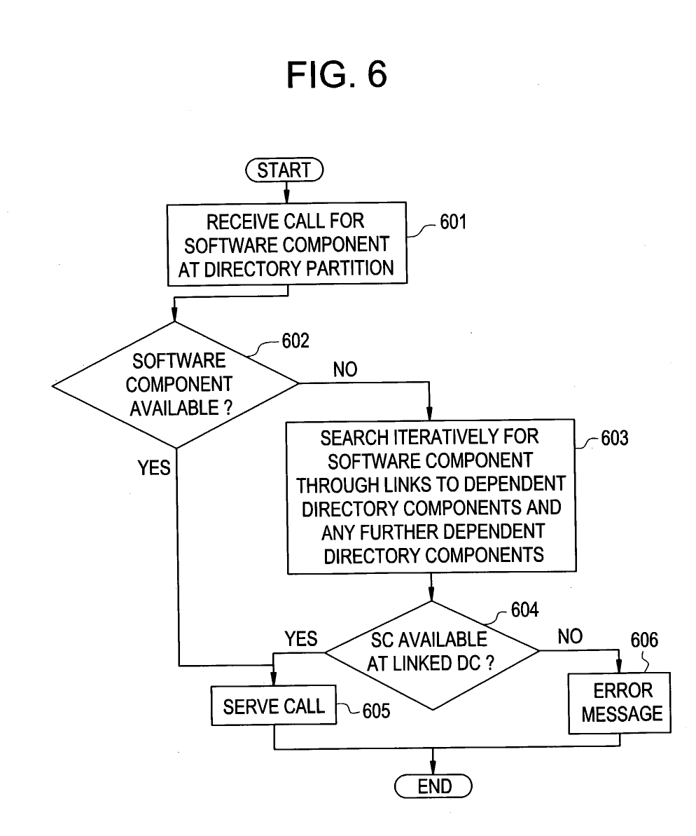

FIG. 6 depicts operations of a method for accessing software components in a storage unit according to another exemplary embodiment consistent with the present invention The operations outlined in FIG. 6 may be carried out by a central processing unit of the data storage unit of one of the previous embodiments, however, FIG. 6 is not limited thereto. The operations could also be carried out by any other control unit executing instructions related to software components stored in directory storage areas.

In a first operation 601 a call for a software component in association with a particular directory storage area is received. This call may include any instruction to execute a software component at this directory storage area.

In an operation 602 it is determined, whether the desired software component is available at the specified directory storage area.

If in operation 602 the decision is “YES”, i.e., if the software component is available at the directory storage area, the call is served in an operation 605, for example, as known in the art. Serving the call may include performing an operation, transferring data, and invoking further software components.

If in operation 602 the decision is “NO”, indicating that the software component is not available at the directory storage area, in an operation 603 a control unit may be instructed to search iteratively for the software component through links to dependent directory components and any further dependent directory components.

This may include an identification of any directory links stored in association with the directory storage area in question and analyzing the directory storage areas. Any dependent directory storage areas may be sequentially accessed trying to identify the desired software component. If the desired software component cannot be identified at any dependent directory storage area, directory links at the dependent directory storage areas could be identified and further dependent directory storage areas could be accessed in search for the desired software component.

Alternatively, operation 603 may involve identifying a first directory link at the directory storage area in question, accessing the dependent directory storage area in search for the desired software component. If the software component cannot be located at this dependent directory storage area a first directory link at the dependent directory storage area may be identified and a further dependent directory storage area may be accessed. These operations may be repeated until a last linked directory storage area is accessed. Thereafter, a second directory link at the original directory storage area may be identified and analyzed and the above operations could be retrieved.

Accordingly, a search for a software component may involve a search on a level-by-level basis, i.e., always moving down to one further layer of directory storage areas. Further, the search for a software component could involve “vertical” sequential investigation of all directory storage areas which can be accessed through each one initial directory link.

Thereafter, in an operation 604 it is determined whether the desired software component is available at any linked directory component. If in operation 604 the decision is “YES”, i.e., the software component is available, in the operation 605, the call is served.

If in operation 604 the decision is “NO”, indicating that the software component is not available at any of the directory storage areas, an error message is presented in an operation 606. Thereafter, the flow of operation ends.

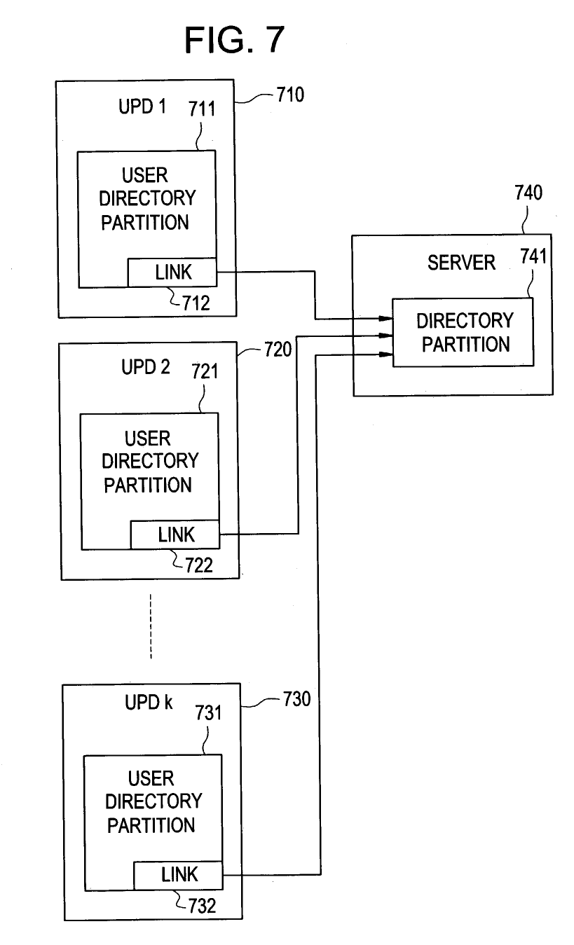

FIG. 7 depicts a data storage unit according to another exemplary consistent with methods and systems of the present invention, particularly depicting a server and client example.

Three user processing devices 710, 720 and 730, respectively include user directory storage areas 711, 721 and 731. A server unit 740 includes a server directory storage area 741.

Each user directory storage area includes a directory link to the server directory storage area 741, i.e., user directory storage area 711 includes a directory link 712 to the server directory storage area 711, user directory storage area 721 includes a corresponding link 722 and user directory storage area 731 includes a link 732 to the directory storage area 741. While in the example of FIG. 7 three user processing devices are shown, it is understood that an arbitrary number of user processing devices can be provided.

The user directory storage areas 711, 721 and 731 may be maintained in association with individual users, either in connection with user processing devices 710, 720 and 730, or in any other environment. The user directory storage areas of the example of FIG. 7 may include user related software components and other information which should not be accessible from third parties. Thus, while a user directory storage area is provided for storing a directory link enabling access to further directory storage areas, such as the server directory storage area 741 shown in FIG. 7, the user directory storage areas cannot be accessed through directory links from another directory storage area. Thus, the information maintained in the user directory storage areas is maintained private, access from the outside from the user directory storage area through a directory link is not possible.

While the user processing devices and the server unit may be arranged on a single system including a single data processing device, the user processing device and the server unit may be part of a distributed system wherein the user processing devices form client units and the server unit may be accessed from the client unit over a network using the directory links.

Access to a user directory storage area through a directory link could be prevented by providing authorization information in association with directory storage areas which is investigated before allowing access to that directory storage area through a directory link. This access information may include a flag, which, if enabled, allows access from other directory storage areas through directory links, and when disabled, does not allow access from other directory storage areas through directory links.

Accordingly, directory links may enable not only access through internal communication paths such as accesses within a data storage device, e.g., through a system bus, but also enable access between separate devices over communication links, including communication networks. In this case accesses through the directory links may involve executing protocols for enabling a communication between the remote devices, as known in the art.

It is noted that the above elements of the above examples may be at least partially realized as software and/or hardware. Further, it is noted that a computerreadable medium may be provided having a program embodied thereon, where the program is to make a computer or system of data processing devices execute functions or operations of the features and elements of the above described examples. A computer-readable medium may include a magnetic or optical or other tangible medium on which a program is embodied, but can also be a signal, e.g., analog or digital, electromagnetic or optical, in which the program is embodied for transmission. Further, a computer program product may be provided comprising the computer-readable medium.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method for accessing files in a data processing system, the system including a plurality of directories, a plurality of modules, a plurality of files, and a plurality of links interconnecting the directories to form a directed acyclic graph, each one of the plurality of directories associated with one of the plurality of modules, each one of the modules requiring at least one of the plurality of files, a group of the plurality of directories each including at least one of the plurality of links, the method comprising the steps of:
selecting one of the plurality of modules;
selecting the file required by the module;
searching the directory associated with the module for the file;
determining whether the file is located in the directory; and
when it is determined that the file is not located in the directory,
accessing the link that interconnects the directory with another one of the directories to identify the other directory;
searching the other directory for the file;
determining whether the file is located in the other directory; and
when it is determined that the file is not located in the other directory,
repeating the steps of accessing, searching the other directory, and determining whether the file is located in the other directory until the file is located.

2. The method of claim 1, wherein the step of searching the other directory further comprises the step of generating a character string including a directory path to the file for the other directory using a name of the file.

3. The method of claim 1, wherein each one of the links includes at least one of
a file,
a pointer, and
a symbolic link.

4. The method of claim 1, wherein the method is performed by at least one of
a compiler program,
an interpreter program, and
a linker program.

5. A method in a data processing system having a program and a plurality of directories, a first one of the directories having a link to a second one of the directories, the method comprising the steps of:
initiating execution of the program; and
during execution of the program,
accessing the first directory to determine whether a needed file is located in the first directory; and
when it is determined that the needed file is not located in the first directory,
accessing the link to determine the second directory as an alternative location for the needed file; and
accessing the second directory to determine if the needed file is contained therein.

6. The method of claim 5, wherein the program comprises a script.

7. The method of claim 5, wherein the step of accessing the first directory further includes accessing the first directory to determine whether a needed file is located in the first directory by executing a test command.

8. The method of claim 5, wherein a third one of the directories has a second link to the first directory, the method further comprising the steps of:
during execution of the program,
accessing the third directory to determine whether the needed file is located in the third directory; and
wherein the step of accessing the first directory further comprises
when it is determined that the needed file is not located in the third directory,
accessing the second link to determine the first directory as a second alternative location for the needed file.

9. The method of claim 5, further comprising the step of generating a character string including a directory path to the needed file for the second directory using a name of the needed file.

10. The method of claim 5, wherein the first link comprises at least one of
a file,
a pointer, and
a symbolic link.

11. The method of claim 5, wherein the program is executed in conjunction with at least one of
a compiler program,
an interpreter program, and
a linker program, and
wherein the needed file is needed by the at least one of the compiler program, the interpreter program, and the linker program.

12. A computer-readable medium encoded with instructions that cause a data processing system, the system having a program and a plurality of directories, a first one of the directories having a first link to a second one of the directories, to perform the steps of:
initiating execution of the program; and
during execution of the program,
accessing the first directory to determine whether a needed file is located in the first directory; and
when it is determined that the needed file is not located in the first directory,
accessing the link to determine the second directory as an alternative location for the needed file; and
accessing the second directory to determine whether the needed file is contained therein.

13. The computer-readable medium of claim 12, wherein the program comprises a script.

14. The computer-readable medium of claim 12, wherein at least one instruction for causing the data processing system to perform the step of accessing the first directory includes a test command.

15. The computer-readable medium of claim 12, wherein a third one of the directories has a second link to the first directory, the medium further encoded with instructions that cause the data processing system to perform the steps of:
during execution of the program,
accessing the third directory to determine whether the needed file is located in the third directory; and
wherein the step of accessing the first directory further comprises
when it is determined that the needed file is not located in the third directory,
accessing the third link to determine the first directory as a second alternative location for the needed file.

16. The computer-readable medium of claim 12, wherein the link comprises at least one of
a file,
a pointer, and
a symbolic link.

17. The computer-readable medium of claim 12, wherein the needed file is needed by at least one of
a compiler program,
an interpreter program, and
a linker program.

18. A data processing system comprising:
a storage unit containing a first directory having a link and a second directory;
a memory having a program that accesses the first directory to determine whether a needed file is in the first directory, and when it is determined that the needed file is not located in the first directory, accesses the link to determine the second directory as an alternative location for the needed file, and accesses the second directory to determine whether the needed file is contained therein; and
a processor for running the program.

19. The data processing system of claim 18, wherein
the storage unit further contains a third directory having a second link to the first directory, and wherein
the program further accesses the third directory to determine whether the needed file is in the third directory, and when it is determined that the needed file is not located in the third directory, accesses the second link to determine the first directory as a second alternative location for the needed file.

20. The data processing system of claim 10, wherein the program includes a script.

21. The data processing system of claim 18, wherein the needed file is needed by at least one of
a compiler program,
an interpreter program, and
a linker program.

22. A data processing system having a program and a plurality of directories, a first one of the directories having a link to a second one of the directories, the data processing system comprising:
means for initiating execution of the program;
means for accessing the first directory to determine whether a needed file is located in the first directory during execution of the program;
means for accessing the link to determine the second directory as an alternative location for the needed file during execution of the program and when it is determined that the needed file is not located in the first directory; and
means for accessing the second directory to determine if the needed file is contained therein during execution of the program and when it is determined that the needed file is not located in the first directory.
